(19) United States
(12) Patent Application Publication
(10) Pub. No.: US 2013/0181096 A1
(43) Pub. Date: Jul. 18, 2013

(54) RV Drain Holder

(71) Applicant: John McKibben, Commerce, TX (US)

(72) Inventor: John McKibben, Commerce, TX (US)

(21) Appl. No.: 13/351,162

(22) Filed: Jan. 16, 2012

(51) Int. Cl. F16L 3/10

(52) U.S. Cl. 248/65

(57) ABSTRACT

A RV drain holder to hold a flexible hose may include a trough to hold the flexible hose and a connector device to connect the trough to connect the drain fitting of the RV with the trough. The connector device may pivot to angle the trough with respect to the horizontal. The trough may be U-shaped. The connector device may include a first L-shaped connector device. The connector device may include a second L-shaped connector device. The first L-shaped connector device may pivot with respect to the second L-shaped connector device. The second L-shaped device may include a horizontal arm to cooperate a sleeve of the trough.

### FIELD OF THE INVENTION

The present invention relates to recreational vehicles (RV)

### BACKGROUND

RV trips can be exciting and fun; until it comes time to dump the waste. The RV operator has to back up to the waste drain area, deploy the waste hose, secure it in the waste inlet, empty the black water tank and then empties the gray water tank(s) to rinse the black water residue from the drain hose. The flexible line droops quite sharply at the trailer/RV and can develop low spots that prevent complete drainage of the hose. This can also leave residual black water solids in the hose and it can develop an unwanted odor later. There is a lot of strain on the drain fitting when the tanks are dumped as the weight of the effluent and hose is supported by the drain fitting.

### SUMMARY

A RV drain holder to hold a flexible hose may include a trough to hold the flexible hose and a connector device to connect the trough to connect the drain fitting of the RV with the trough.

The connector device may pivot to angle the trough with respect to the horizontal.

The trough may be U-shaped.

The connector device may include a first L-shaped connector device.

The connector device may include a second L-shaped connector device.

The first L-shaped connector device may pivot with respect to the second L-shaped connector device.

The second L-shaped device may include a horizontal arm to cooperate a sleeve of the trough.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the flexible hose extending out of the recreational vehicle (RV);

FIG. 2 illustrates the drain holder stored in the cabinet;

FIG. 3 illustrates the top view of the lock device of the present invention;

FIG. 4 illustrates an end view of the lock device of the present invention;

FIG. 5 illustrates a side view of the lock device of the present invention

FIG. 6 illustrates a side view of the storage cabinet of the present invention;

FIG. 7 illustrates an end view of the nested U-shaped troughs of the present invention;

FIG. 8 illustrates a top view of the U-shaped trough of the present invention;

FIG. 9 illustrates a side view of the U-shaped trough of the present invention;

FIG. 10 illustrates a perspective view of the U-shaped troughs of the present invention;

FIG. 11 illustrates an end view of the U-shaped trough of the present invention;

FIG. 12 illustrates a side view of a connector device of the present invention;

FIG. 13 illustrates a perspective view of a cabinet device of the present invention;

FIG. 14 illustrates a perspective view of U-shaped troughs of the present invention;

FIG. 15 illustrates another perspective view of the U-shaped troughs of the present invention;

FIG. 16 illustrates an end view of the U-shaped troughs of the present invention

FIG. 17 illustrates an end view of the band connector of the present invention.

### DETAILED DESCRIPTION

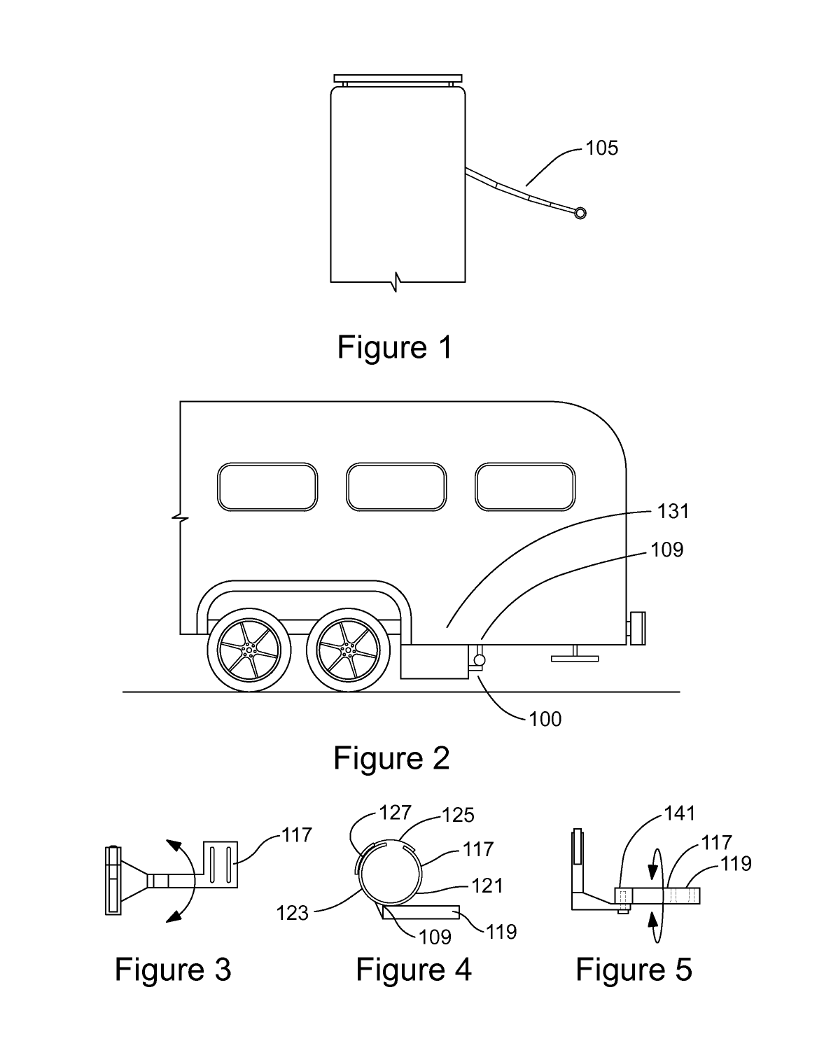

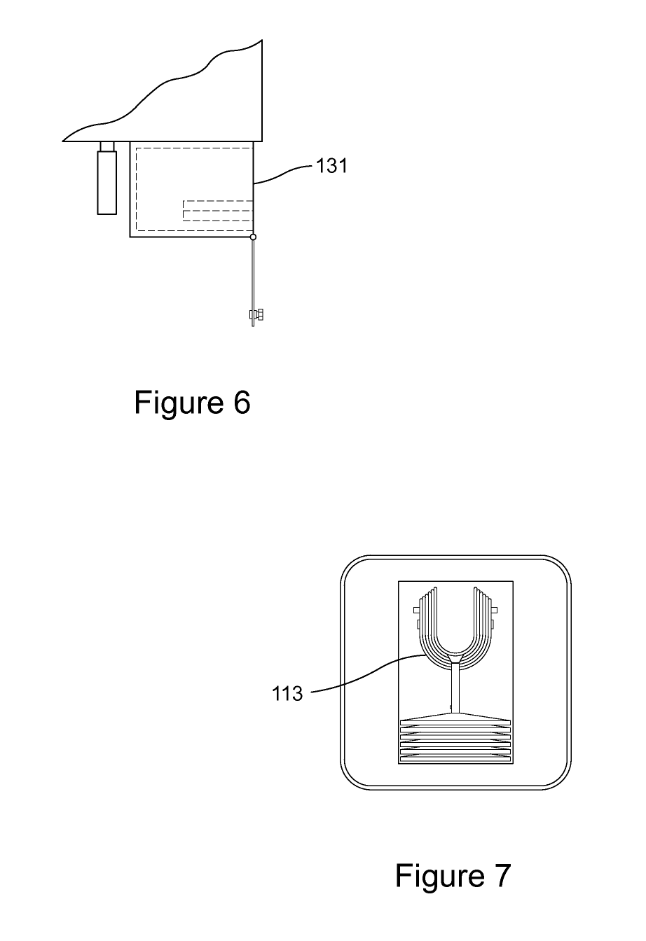

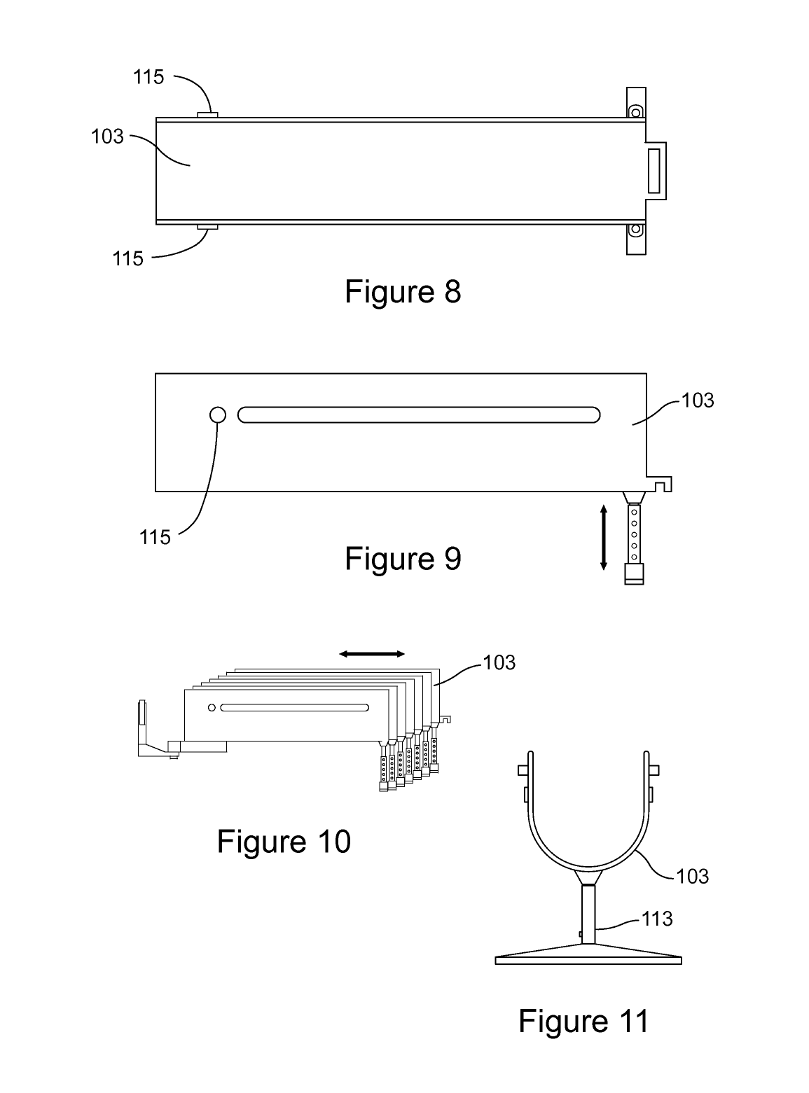

FIGS. 1-12 illustrates the RV drain holder 100 of the present invention. The RV Drain Holder 100 is a travel product that provides easy deploying support to a waste drain line to drain wastewater on travel trailers and recreational vehicles. The RV Drain Holder 100 stores compactly under the vehicle in a cabinet designed to fit into the trailer's exterior decor.

The RV Drain Holder 100 is deployed by simply pulling it out of the cabinet, extending the RV Drain Holder 100 to the waste receptacle inlet, and attaching the waste hose to the drain fitting. The substantially ‘U’ shaped troughs 103 support the flexible hose 105 and the legs 107 provide a built in slope to provide the optimum drainage.

After use, the RV Drain Holder 100 slides back together, is rotated approximately 90°, and then pivoted approximately 90° to store compactly in the under trailer cabinet.

The RV Drain Holder 100 is designed to be easy to use and store the waste drain hose support.

The RV Drain Holder 100 resolves these problems and fits in a compact storage under the trailer/RV when not being used.

To use the RV Drain Holder 100, the RV operator unlocks and opens the cabinet door, pivots the U channel or U-shaped trough 103 outward, rotates the U-shaped trough 103 approximately 90° so the legs and feet point toward the ground, operates the extension tray hook 107, and slides the U-shaped trough 103 out toward the waste receptacle inlet.

The RVer then deploys the flexible hose or waste drain hose 105, attaches the waste drain hose 105 to the drain fitting 109 and waste receptacle inlet (not shown), and secures the end in the last support tray or U-shaped trough 103 with the bungee cord to keep it from blowing out of the ‘U’ channel 103 when it is windy.

The “RV Drain Holder” is an innovative travel product that has been designed to provide easy deploying support to the waste drain line or flexible hose 105 on travel trailers and recreational vehicles. The RV Drain Holder 100 stores compactly under the vehicle in a cabinet designed to fit into the trailer's exterior decor. The RV Drain Holder 100 is deployed by pulling the RV Drain Holder 100 out of the cabinet, extending the RV Drain Holder 100 to the waste receptacle inlet, and attaching the waste hose or the flexible hose 105 to the drain fitting 109. A multitude of U-shaped troughs 103 support the flexible hose 105 and the support legs 113 provide a built in slope to provide the drainage. After use, the RV Drain Holder 100 slides back together, is rotated approximately 90°, and then pivoted approximately 90° to store compactly in the under trailer cabinet.

The RV Drain Holder 100 resolves these problems and fits in a compact storage under the trailer/RV when not being used. The six support trays or U-shaped troughs 103 are fitted with adjustable support legs 113 for the support of the drain line or flexible hose 105. There may be a slope built into the support legs 113 by being successively shorter from the drain fitting 109 positioned above the ground. The legs can be individually height adjusted to a support tray or U-shaped trough 103 of varying heights above the support surface which may be the ground. This height adjustment accommodates most RVs.

The U-shaped troughs 103, the support legs 113, and the feet may be injection molded using polypropylene plastic or other appropriate material.

The first tray or first U-shaped trough 103 in the array of stacked U-shaped troughs 103 may include fasteners which may be a PEM® nut reinforced screw holes for the mounting screws on the lock device 117 to attach to the drain fitting 109. The last tray or U-shaped trough 103 in the array of U-shaped troughs 103 may include a bungee cord to restrain the extension tray hook molded into the product. The support legs 113 may be attached to the feet using adhesive bonding techniques and the support legs 113 may be chemically bonded to the reinforcements molded in the end of the tray or U-shaped trough 103. The RV drain holder 100 may include multiple legs having varying lengths being successively shorter than the previous one. When secured on the support trays, this provides the a slope for the flexible drain hose 105.

An additional extension support tray may be used with the present invention to reach a distant waste receptacle inlet. The same slope may be obtained and may be fabricated in the same manner with the same materials.

The lock device 117 may be also injection molded from polypropylene plastic. The locker device 117 may include a base 119 for the clamp 127, a first arm 121, a second arm 123, a wire bail 125 and will and

which may be formed from stainless steel, and an over center clamp 127 which may be formed from stainless steel. The lock device 117 may be opened and then closed over the drain fitting behind waste drain hose attachment. The bottom of the clamp 127 includes a pivot section including a pivot 141 and rotation section. The rotation section may have 2 sliding fasteners that cooperate with the fasteners 115 by screwing into the bottom of the first tray's PEMS nuts. The lock device 117 uses this swivel action to allow the U-shaped troughs 103 to be vectored toward the waste receptacle. The rotation section allows the product to be rotated approximately 90° and stored in the storage cabinet 131. If desired, and the storage cabinet 131 will not fit under the trailer/RV, the lock device 117 allows the product to easily be removed and stored in the RV storage locker.

The storage cabinet 131 is fabricated out of the same materials as the trailer/RV so it will blend into the vehicle's decor. The exterior of the storage cabinet 131 may be made using pre-coated sheet metal. The storage cabinet 131 may be folded and riveted together to make a substantially watertight enclosure. The interior of the cabinet 131 may be covered with a layer of open cell waterproof foam to protect the RV drain holder and reduce rattles during driving. Apertures may be provided for mounting the cabinet 131 with seals so the environment may be prevented from entering into the cabinet. In one wall of the cabinet 131, an opening will be cut to accept the lock shaft 133. The shaft 133 may be facing toward the rear of the vehicle and may be made splash proof using rubber sheeting and nylon bristle seals. The front door of the cabinet 131 may hinge downward and may be secured with one or two cabinet style locks. The edges of the door may seal against a compressible weather strip so no moisture can intrude.

The RV drain holder 100 may be designed to be aesthetic and effective in the application. The user benefits from an easy deploying and storing waste drain hose support, which should provide considerable market interest in the product.

Travel trailer is backed up to the waste drain.

The U-shaped trough 103 is pulled out of the storage cabinet 131 and deployed to hold the flexible drain hose.

The U-shaped trough 103 can be pivoted to direct it toward the waste drain and slightly bent around any obstacles. In use, the RV operator unlocks and opens the cabinet door, pivots the U-shaped trough 103 outward, rotates it 90° so the legs and feet point toward the ground, grabs the extension tray hook, and slides the U-shaped trough 103 out toward the waste receptacle inlet. This operation takes just a few seconds and is incredibly simple. The U-shaped trough 103 may include the capability to pivot when fully extended, allowing the U-shaped trough 103 to curve around obstacles if they happen to be in the way. The RVer then deploys the waste drain hose 105, attaches it to the drain fitting 109 and and waste receptacle inlet, and secures the end of the flexible hose 105 in the last U-shaped trough 103 with the bungee cord to keep it from blowing out of the U-shaped trough 103 when it is windy. The legs can be adjusted in the vertical height if required to compensate for the variation in terrain. The feet provide stability during use.

After use the U-shaped trough 103 can be slid back together, rotated 90°, and then pivoted into storage cabinet 131. To store the product, the hose 105 is put away, the extension hook is picked up slightly and the trays are slid back together. Then the compressed U-shaped trough 103 may be rotated 90° with the feet toward the trailer, the U-shaped trough 103 lifted slightly, then pivoted 90° to store in the cabinet. This operation takes just a few seconds as well. When everything is stored, the cabinet door is locked and everything is secure until the next use.

The lockable cabinet holds the stored U-shaped trough 103 until it is deployed for the next use.

The storage cabinet 131 is fabricated from typical trailer materials so it blends into the trailer design. The storage cabinet 131 may be fabricated out of the same materials as the trailer/RV so it will blend into the vehicle's decor. The exterior may be made using pre-coated sheet metal. The storage cabinet 131 may be folded and riveted together to make a watertight enclosure. The interior of the cabinet 131 will be covered with a layer of thick open cell waterproof foam to protect the product and reduce rattles during driving. Holes will be provided for mounting the cabinet with seals so the environment will not be allowed into the cabinet. In one wall, an opening will be cut to accept the fast lock shaft. This will always be facing toward the rear of the vehicle and will be made splash proof using rubber sheeting and nylon bristle seals. The front door will hinge downward and will be secured with one or two cabinet style locks. The edges of the door will seal against a compressible weather strip so no moisture can intrude.

The fast lock is secured on the trailer/RV waste drain fitting and holds the support in the correct position during use and storage.

The shaft of the fast lock slips through the rubber and bristle seal at the rear side of the cabinet.

The hinged outer door on the cabinet may employ a stainless steel continuous hinge for a corrosion resistant support.

The rubber sheet and nylon bristle seal keep the cabinet interior dry and debris free.

The interior of the cabinet 131 may be coated with thick open cell foam for cushioning. The open cell EVA foam will not take a set and is waterproof so it can be cleaned if the feet bring in dirt or mud.

The lock device 117 may be supplied with 2 hinges to allow it to open fully for easy installation and removal. The lock device 117 may be also injection molded from polypropylene plastic. The lock device 117 may include a base for the clamp, two arms, a stainless steel wire bail, and a stainless steel over center clamp. This end is opened and then closed over the drain fitting behind waste drain hose attachment. The bottom of the clamp may include a pivot section and rotation section. The rotation section may include 2 sliding fasteners that screw into the bottom of the first tray's PEM® nuts. The lock device 117 uses this swivel action to allow the support to be vectored toward the waste receptacle inlet with a minimum of fuss. The rotation section allows the RV drain holder 100 to be rotated substantially 90° and stored in the cabinet. If desired, and the storage cabinet 131 will not fit under the trailer/RV, the fast clamp allows the RV drain holder 100 to be removed and stored in the RV storage locker. The pivot motion allows the U-shaped troughs 103 to rotate substantially 180° so it can easily be aimed at the waste inlet on the site waste tank.

The base also pivots approximately 90° to allow storage of the collapsed U-shaped troughs 103 with the U-shaped troughs 103 sliding upward on the base. The assembly is lifted slightly so it centers itself in the cabinet 131 when being stored. When the U-shaped trough 103 is deployed, the U-shaped trough 103 may be allowed to drop down so it centers itself under the drain fitting in use.

Lock device 117 fits over the trailer/RV waste drain pipe.

The lock device 117 pivots approximately 180° and rotates at approximately 90° so the legs are parallel to the ground during storage, which allows the U-shaped trough 103 to fit compactly under the trailer/RV.

The support legs 113 provide nested support with height adjustable legs, which are terminated with feet.

Extension Trough Hook and Control Handles

Tabs slide inside the next outside U-shaped trough 103, (6 total). The U-shaped trough 103, the support legs 113, and the feet may be injection molded using polypropylene plastic .This plastic is very durable, is highly resistant to waste water chemicals and ultraviolet light, and is typically used in this type of application. The thick wall of the U-shaped trough 103, legs 113, and feet may be supplied in almost any vibrant color, so a distinctive color may be chosen to enhance the t recognition factor of the RV drain holder 100, which can dramatically improve the market adoption of the RV drain holder 100. The first U-shaped trough 103 in the nested array may include the fasteners 115 including the PEW@ nut reinforced screw holes for the mounting screws on the fast lock. The last tray in the array has the bungee cord restraints and the extension tray hook molded into the RV drain holder 100. The legs may be attached to the feet using adhesive bonding techniques and the legs are chemically bonded to the reinforcements molded in the end of the tray. The legs may be successively smaller with each one being shorter than the previous by a predetermined amount. When secured on the support trays, this provides the slope for the drain hose. Storage cabinet 131 minimum dimensions.

A bungee cord may cooperate with the U-shaped trough 103 by going over the end in smallest trough to secure the drain hose 105 from being blown out by the wind. The rubber bungee cord may be included with the RV drain holder 100.

The bungee tables and the extension trough hook are formed on the most interior (smallest) trough.

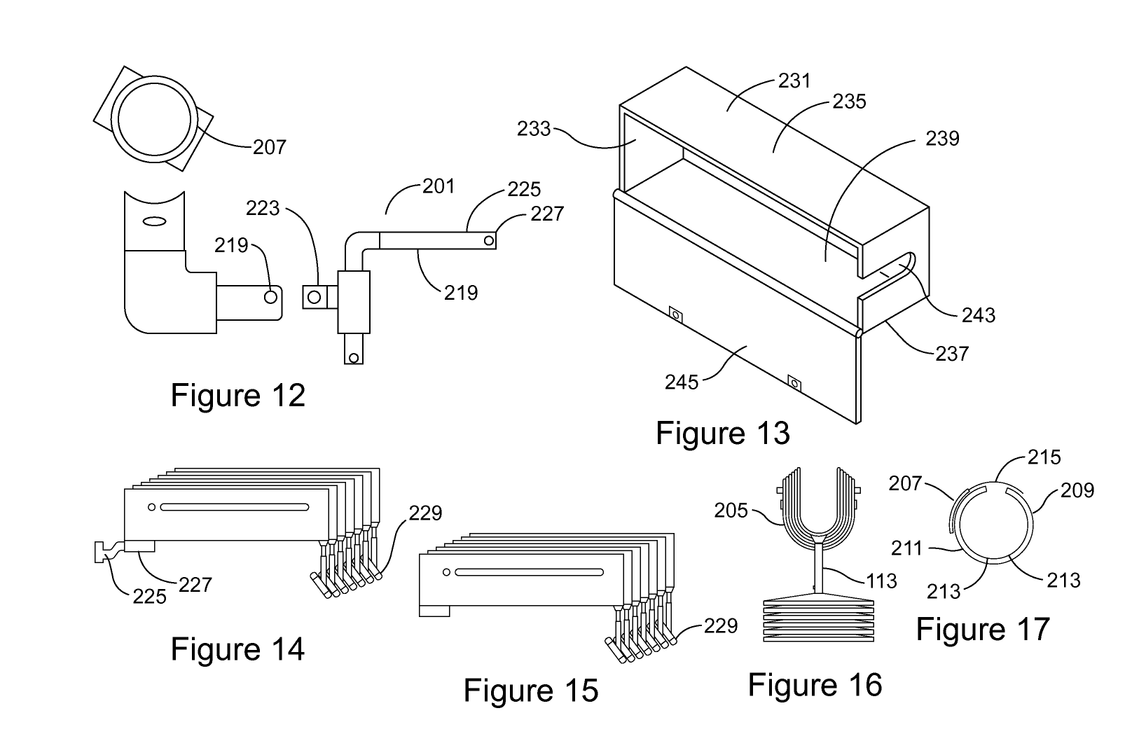

FIG. 12-17 illustrates another RV drain holder 200 of the present invention. FIG. 12 illustrates a connection device 201 to connect to the drain fitting 109 and is similar to the lock device 117 is shown in FIGS. 3-5 and may include a first clamp 209 which may pivot on pivot point 213 and a second clamp 211 which may pivot on pivot point 213. The first clamp 219 and the second clamp 211 may be connected by an arm 215 which may lock the first clamp 219 and the second clamp 211 in position around the drain fitting 109. Additionally, the band connector 207 connects the drain fitting 109 to a first L-shaped connector device 217 which may be PCV pipe which may be connected to a second L-shaped connector device 219 by a pivoting connection point 221 which may include a first aperture 219 and the first L-shaped connector 217 to a second aperture 223 of the second L-shaped connector device 219 to allow the first L-shaped connector device 217 to pivot with the second L-shaped connector device 219 and to change the angle of the U-shaped troughs 205 with respect to the horizontal. The second L-shaped connector device 219 may include a horizontal arm 225 to be inserted into a sleeve 227 which may be connected to the U-shaped troughs 205. The horizontal arm 225 may accept a pin through an aperture 227 to retain the horizontal arm 225 within the sleeve 227 to support the U-shaped trough 205.

FIG. 14 illustrates the horizontal arm 225 within the sleeve 227 additionally illustrates the nested feet 229.

FIG. 15 illustrates the sleeve 227 without the horizontal arm 225 so that the second L-shaped connector device 219 may be detachably connected from the sleeve 217 and the U-shaped troughs 205.

FIG. 13 illustrates a storage container 231 which may include a first end wall 233 which may be connected to a front wall 235, a back wall 237 and a bottom wall 239 and which may include a second end wall 241 which may include a slit 243 and which may be connected to the front wall 235, the back wall 237 and the bottom wall 239. The storage container 231 may include a top wall 245 which may be pivotably connected to the back wall 237.

FIG. 16 illustrates the U-shaped troughs 205 and the support legs 113.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A RV drain holder to hold a flexible hose, comprising:
a trough to hold the flexible hose;
a connector device to connect the trough to connect the drain fitting of the RV with the trough;
wherein the connector device pivots to angle the trough with respect to the horizontal.

2) A RV drain holder to hold a flexible hose as in claim 1, wherein the trough is U-shaped.

3) A RV drain holder to hold a flexible hose as in claim 1, wherein the connector device includes a first L-shaped connector device.

4) A RV drain holder to hold a flexible hose as in claim 3, wherein the connector device includes a second L-shaped connector device.

5) A RV drain holder to hold a flexible hose as in claim 4, wherein the first L-shaped connector device pivots with respect to the second L-shaped connector device.

6) A RV drain holder to hold a flexible hose as in claim 4, wherein the second L-shaped device includes a horizontal arm to cooperate a sleeve of the trough.
